(19) United States
(12) Patent Application Publication
(10) Pub. No.: US 2012/0093443 A1
(43) Pub. Date: Apr. 19, 2012

(54) LEAK-PROOF RECYCLABLE PAPER BAG AND METHOD OF MANUFACTURER

(76) Inventor: Christopher Joseph Klein, Independence, KY (US)

(21) Appl. No.: 12/904,760

(22) Filed: Oct. 14, 2010

(51) Int. Cl. B65D 33/00; B31B 1/62

(52) U.S. Cl. 383/211; 493/210; 493/220

(57) ABSTRACT

An all-paper bag is provided that is leak-proof and biodegradable (recyclable). The bag is customized to a desired length, includes a heat sealed bottom and is coated on the inside with a water resistant material. In some cases, the bag includes a top strip for completely sealing the bag when liquid is stored therein.

### BACKGROUND

Increasingly, the world is becoming environmentally conscious and aware. Nowhere is the need for environmental awareness more acute then in the bagging and waste disposal industry. Typically, consumers use plastic bags to bag groceries; albeit in recent years a move has been afoot to have the consumers use personal or sustainable paper bags that can be reused each time the consumer visits a grocery store. With waste disposal, most trash or recyclable bags are made of plastic which liter the landfills of municipalities, and drastically complicate and increase the cost of recycling efforts.

Another concern is that when liquid refuse is being transported or being disposed of in some manner, a can, a bottle, a bag, ajar, and/or tank are needed to securely house the liquid. That is, there is no commercial grade means for distributing liquid refuse, along with other recyclable materials, in recyclable bags, especially not recyclable paper bags.

### SUMMARY

In various embodiments, leak-proof recyclable paper bags and the methods of manufacturing the same are provided. More particularly and in an embodiment, a bag is provided. The bag is an all-paper bag in a tube shape. The interior of the paper bag is coated with water resistant material that includes a hot melt water resistant adhesive along a Fin Style side seam of the paper bag. A bottom to the paper bag is folded and a hot melt poly ethylene adhesive pattern is applied, and in combination with a heat and pressure seal application to form a bottom closure and seal of the paper bag. The interior of the bag is water resistant or leak proof, such that transportation of liquid materials in the paper bag is achievable.

### BRIEF DESCRIPTION OF THE DRAWINGS

FIG. 1 is a diagram of a leak-proof bag, according to an example embodiment.

FIG. 2 is a diagram of another leak-proof bag, according to an example embodiment.

FIG. 3 is a diagram of a method for manufacturing a leak-proof bag, according to an example embodiment.

### DETAILED DESCRIPTION

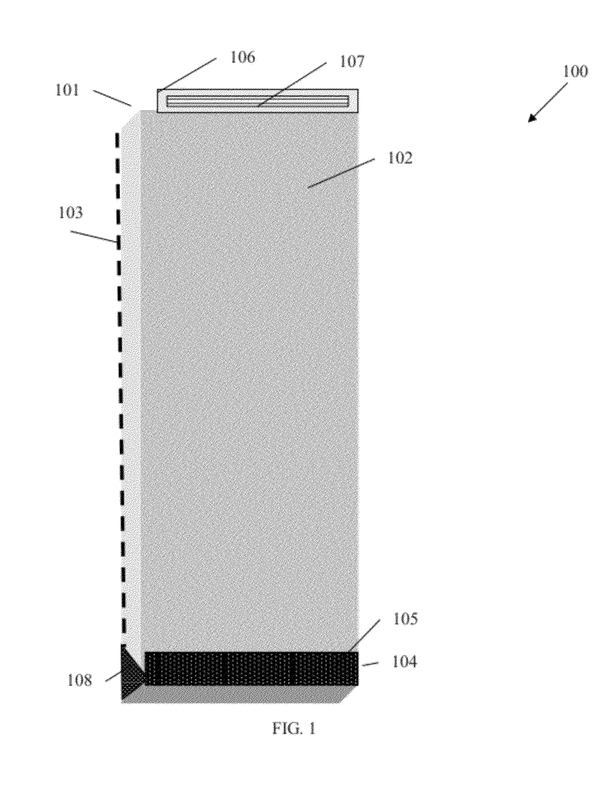

FIG. 1 is a diagram of a leak-proof bag 100, according to an example embodiment. The leak-proof 100 is made of all paper-based material, such as but not limited to Kraft or bleached Kraft paper. It is also noted that the leak-proof bag is leak proof and designed and constructed to hold liquid.

The leak-proof bag 100 includes a paper bag 101 manufactured in a tube shape. It is noted that the tube shape is show for purposes of illustration and that other shapes can be achieved without departing from the beneficial teachings provided herein.

In an embodiment, the paper bag 101 is constructed of single ply 1#-135# basis weight, per paper bag industry standards, or 3000 square feet measurement, of Kraft paper, coated or uncoated paper, or bleached Kraft paper.

In another case, the paper bag 101 is constructed of double ply 1#-135# basis weight Kraft, coated or uncoated paper, or bleached Kraft paper. Here, the double ply can also include an exterior layer of Wet Strength Paper.

The interior 102 of the paper bag 101 is coated with poly ethylene or other similar coatings or water/liquid resistant chemicals, at between 1#-50# basis weight. In some embodiments, the interior 102 of the paper bag 101 is coated with a non poly ethylene material that is includes water resistant properties or barriers.

Adhesives used are water resistant, such as a hot melt poly ethylene adhesive.

The paper bag 101 can also include a side seam 103 that has a hot melt water resistant adhesive applied to the seam 103.

In an embodiment, the side seam 103 is a Fin style side seam, which is a technique that folds an inner seam of the paper bag 101 before adhesion occurs, allowing for the coating surface of the inner lining of the paper bag 101 to be bond to another coated surface, which produces improved leak-proof protection.

Furthermore, the paper bag 101 has a folded bottom 104 that can be folded one or two times with a hot melt adhesive pattern 105 applied to form a bottom closure of the paper bag 101. The folding provides structural support and maintains a seal of any liquid being transported in the paper bag via the hot melt adhesive pattern 105. The bag 101 can also contain no fold and still maintain leak-proof qualities.

According to an embodiment, the paper bag 101 also includes a top strip 106 used for sealing an opening of the paper bag 101 to fully encapsulate any liquid being stored or transported in the paper bag 101. In other embodiments, the bag 101 can also not include the top strip as well.

In one case, the top strip 106 includes a strip of double sided adhesive tape 107 that can be used to seal the opening via the top strip 106 when folded over an opposing side of the paper bag 101. Other forms of sealing mechanisms may be used as well, such that the opening is water sealed and closed on the paper bag 101.

In yet another configuration, the top strip 106 includes a removal strip of paper or plastic that when removed exposes adhesive on one side of the top strip 106; thereby permitting the top strip 106 to seal the opening of the paper bag 101 via the exposed adhesive.

In an embodiment, the paper bag 101 can include one or more gussets 108 woven into the sides of the paper bag 101 for added support. The size and placement of the gussets 108 can vary based on the strength of the paper bag 101 being manufactured and the volume of liquid that the paper bag 101 is being designed to support.

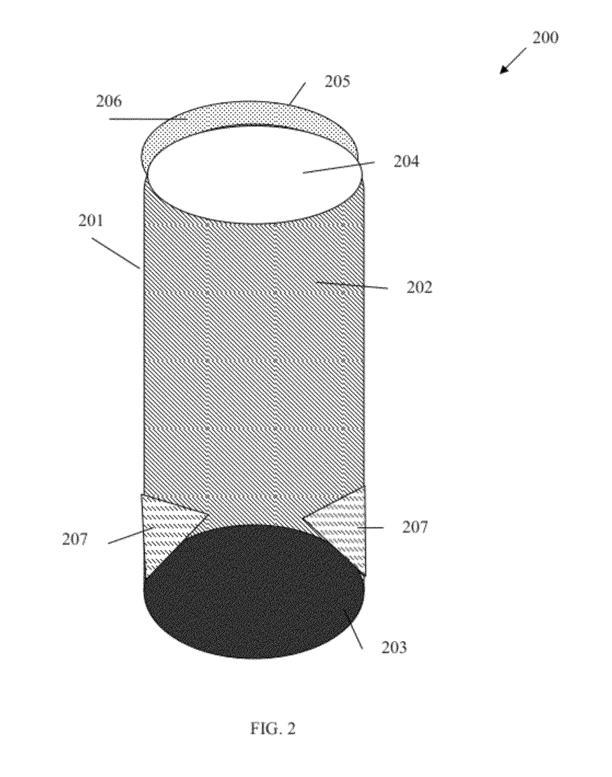

FIG. 2 is a diagram of another leak-proof bag 200, according to an example embodiment.

The leak-proof bag 200 includes a paper tube 201 that is configured to a desired height, width, and length. The waterproof bag 200 also includes an interior 202 to the paper tube 201 that is coated with water resistant material. Moreover, the leak-proof bag 200 includes a bottom 203 of the paper tube 201 that is configured to be folded (zero, one, or multiple times) and heat sealed at the bottom 203 of the paper tube 201 to close one end of the paper tube 201.

In an embodiment, the paper tube 201 also includes an opening 204 having a strip of paper 205 extending beyond the opening 204 on one side of the paper tube. This is used for closing and sealing the opening 204.

Continuing with the previous embodiment and in another situation, the strip 205 includes adhesive 206 that permits the strip to be folded over another side of the paper tube 201 to close and water seal the paper tube 201.

In some cases, the leak-proof bag 200 also includes one or more gussets 207 of configurable sizes and locations on the paper tube for needed support based on the size and configuration of the paper tube 201.

In an embodiment, the paper tube 201 is 1 to 450 inches tall and 1 to 50 inches wide.

In an embodiment, the gusset 207 for the paper tube 201 is 1 to 20 inches.

In another case, the paper tube 201 includes double sided adhesive tape that is water resistant and is used to seal the opening 204 of the paper tube 201 closed.

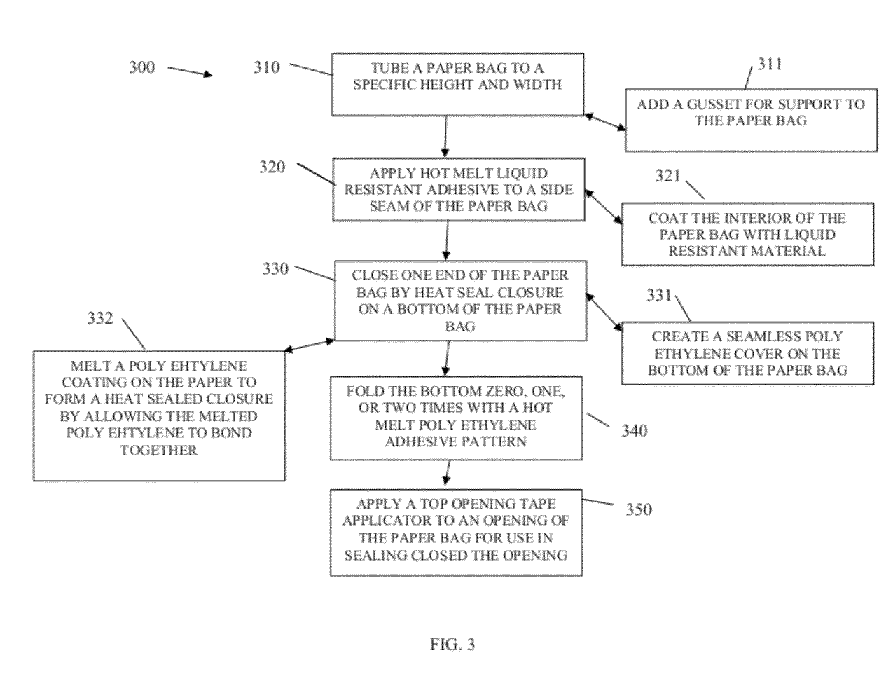

FIG. 3 is a diagram of a method 300 for manufacturing a leak-proof bag, according to an example embodiment. The method 300 (herein after “paper bag manufacture process”) is implemented by machinery designed to produce paper bags.

At 310, the paper bag manufacture process tubes a paper bag to a specific desired height, length, and width.

According to an embodiment, at 311, the paper bag manufacture process adds one or more gussets for support to the paper bag. Again, the gusset can be configured to a length, height, and/or width.

At 320, the paper bag manufacture process applies hot melt water resistant adhesive to a side seam of the paper bag.

In an embodiment, at 321, the paper bag manufacture process coats the interior of the paper bag with water/liquid resistant materials.

At 330, the paper bag manufacture process puts the paper bag through a heat sealing/closing mechanism or machine. So, one end of the paper bag is closed by heat seal closure on a bottom of the paper bag.

According to an embodiment, at 331, the paper bag manufacture process creates a seamless poly ethylene or similar water/liquid resistant chemical cover on the bottom of the paper bag.

Also, at 332, a poly ethylene or similar water/liquid resistant chemical coating is mildly heated and melted on the paper bag to form a heat seal closure by allowing the melted poly ethylene to bond together.

At 340, the paper bag manufacture process folds the bottom zero, one, or two times with a hot melt poly ethylene adhesive pattern and appropriate temperature and pressure heat seal application.

In an embodiment, at 350, the paper bag manufacture process is run through a top opening applicator. This process allows for the placement of a top sealing application that an end user of the paper bag can use. Other forms or top sealing techniques, such as fit for automatic packaging, can be used as well. So, at 350, the paper bag manufacture process can apply a top opening tape applicator to an opening of the paper bag for use in sealing closed the opening.

The paper bags described herein are composed of a unique set of components, combined with an equally unique set of manufacturing techniques, which when combined, form a new and novel paper bag that is both leak proof for extended periods of time and recyclable. Additionally, the attribute that a mix of components used can be certified as recyclable is unique in and of itself.

In some embodiments, paper recyclable handles can be added to the paper bag for carrying the paper bag.

The paper bag can hold any type of liquid, such as water, wine, etc.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

The Abstract is provided to comply with 37 C.F.R. §1.72(b) and will allow the reader to quickly ascertain the nature and gist of the technical disclosure. It is submitted with the understanding that it will not be used to interpret or limit the scope or meaning of the claims.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus the following claims are hereby incorporated into the Description of the Embodiments, with each claim standing on its own as a separate exemplary embodiment.

1. A bag, comprising:
a paper bag in a tube shape, an interior of the paper bag is coated with liquid resistant material and includes a hot melt liquid resistant adhesive along a Fin style side seam of the paper bag, a bottom of the paper bag is folded with a hot melt poly ethylene adhesive pattern to form a bottom closure of the paper bag.

2. The bag of claim 1, wherein the paper bag is single ply 1# to 135# basis weight Kraft or Bleached Kraft paper.

3. The bag of claim 1, wherein the paper bag is double ply 1# to 135# basis weight Kraft or Bleached Kraft paper.

4. The bag of claim 1, wherein the interior of the paper bag is coated with ply ethylene at between 1# to 50# basis weight.

5. The bag of claim 1, wherein the paper bag further includes a top strip that is adapted to be sealed along an opening of the paper bag.

6. The bag of claim 5, wherein the top strip includes double sided adhesive tape with a plastic removal strip.

7. The bag of claim 5, wherein the top strip includes a removal strip of paper that when removed exposes an adhesive on one side of the top strip permitting the top strip to seal the opening of the paper bag.

8. A bag, comprising:
a paper tube configured to a desired height, width, and length;
an interior of the paper tube coated with a liquid resistant material; and
a bottom of the paper tube configured to be folded zero, one, or multiple times and heat sealed at the bottom of the paper tube to close one end of the tube.

9. The bag of claim 8 further comprising, an opening of the paper tube opposite the bottom and having a strip of paper extending beyond the opening on one side of the paper tube.

10. The bag of claim 9, wherein the strip includes adhesive that folds over another side of the paper tube to close and water seal the paper tube.

11. The bag of claim 8 further comprising, the paper tube includes a gusset for support.

12. The bag of claim 8, wherein the paper tube is 1 to 60 inches tall and 1 to 50 inches wide.

13. The bag of claim 12, wherein paper tube includes a 1-20 inch gusset.

14. The bag of claim 8, wherein the paper tube includes double sided adhesive tape that is water resistant and is used to seal the opening of the paper tube closed.

15. A method, comprising:
tubing a paper bag to a specific width and height;
applying hot melt liquid resistant adhesive to a side seam of the paper bag;
closing one end of the paper bag by heat seal closure on a bottom of the paper bag; and
folding the bottom zero, one, or two times with a hot melt poly ethylene adhesive pattern.

16. The method of claim 15 further comprising, applying a top opening tape applicator to an opening of the paper bag for use in sealing closed the opening.

17. The method of claim 15, wherein tubing further includes adding a gusset for support to the paper bag.

18. The method of claim 15, wherein applying further includes coating the interior of the paper bag with a liquid resistant material.

19. The method of claim 15, wherein closing further includes creating a seamless poly ethylene cover on the bottom of the paper bag.

20. The method of claim 15, wherein closing further includes melting a poly ethylene coating on the paper to form a heat sealed closure by allowing the melted poly ethylene to bond together.
